(19) United States
(12) Patent Application Publication
(10) Pub. No.: US 2024/0232807 A9
(43) Pub. Date: Jul. 11, 2024

(54) SYSTEM FOR DYNAMIC REMINDERS FOR ITEMS WITH LEGAL DEADLINES

(71) Applicant: Black Hills IP Holdings, LLC, Minneapolis, MN (US)

(72) Inventors: Steven W. Lundberg, Edina, MN (US); Russell D. Slifer, Boise, ID (US)

(21) Appl. No.: 18/351,428

(22) Filed: Jul. 12, 2023

Related U.S. Application Data
(60) Provisional application No. 63/419,213, filed on Oct. 25, 2022.

(51) Int. Cl. G06Q 10/10

(52) U.S. Cl. CPC G06Q 10/103

(57) ABSTRACT

Various embodiments disclosed relate to an automated dynamic reminder tool for project management. The present disclosure includes a method of receiving an indication of a task to be worked on, the task to be worked on associated with a deadline, a party responsible for the deadline, and a cost associated with the deadline, wherein the cost is related to an expense incurred for extending the deadline; determining, based on the task and the deadline, at least one or more reminders associated with the task to be worked on; prioritizing the one or more reminders associated with the task to be worked on based on one or more of the deadline, the party responsible, and the cost associated with the task to be worked on; displaying, on a user interface at least one of the one or more prioritized reminders; and dynamically updating the one or more reminders based on the party responsible for the deadline and the cost associated with the deadline.

### CLAIM OF PRIORITY

This application claims the benefit of priority under 35 U.S.C. § 119(e) to U.S. Provisional Patent Application Ser. No. 63/419,213, filed on Oct. 25, 2022, and which is incorporated by reference herein in its entirety.

### TECHNICAL FIELD

The application is directed toward an electronic docketing system and, more specifically, to an electronic docketing system that provides dynamic reminders for projects, tasks, and items with deadlines.

### BACKGROUND

In a business, docketing systems may be used to track workflow deadlines, tasks, and progress. For example, in a given project, a docketing system may track when the project is opened, what initial filings are due when, and correspondence coming in regarding that project. The docketing system may additionally be used to record deadlines and flag correspondence or documents that may require a response. However, in a general docketing setting, a large number of items and tasks are incoming and often need to be sorted during docketing. Typically, many deadlines and reminders are created to manage such a system and portfolio.

### SUMMARY OF THE DISCLOSURE

The present disclosure provides a system and method of providing dynamic reminders for projects, tasks, and items with deadlines, such as in a patent docketing system. Generally, management of a patent docket may involve a large amount of deadline management, such as sending reminders to the worker(s) on the patent docket. Often, a patent practitioner has a large number of cases being worked on simultaneously, creating a large patent docket to track and manage. For example, a patent practitioner may have upwards of one hundred matters on her docket, each of which has different deadlines.

In a patent prosecution setting, many deadlines involve various fees. Some deadlines are extendable, others are not. In a given time period, such as a week or a month, the practitioner may have a variety of deadlines, some of which involve fees, some of which are extendable, and each on various matters. Creating a management system to determine which deadlines to prioritize is very useful for such a practitioner.

The methods and system discussed herein may help a practitioner to prioritize specific deadlines. The methods may use a variety of criteria to determine which deadlines should be prioritized, such as the amount of time required for the task, the cost of extending a deadline, importance of a matter, or other criteria.

In an example, an automated reminder method includes: receiving an indication of a task to be worked on, the task to be worked on associated with a deadline, a party responsible for the deadline, and a cost associated with the deadline, wherein the cost is related to an expense incurred for extending the deadline; determining, based on the task and the deadline, at least one or more reminders associated with the task to be worked on; prioritizing the one or more reminders associated with the task to be worked on based on one or more of the deadline, the party responsible, and the cost associated with the task to be worked on; displaying, on a user interface at least one of the one or more prioritized reminders; and dynamically updating the one or more reminders based on the party responsible for the deadline and the cost associated with the deadline.

In an example, a system for creating automated reminders includes: a memory that stores instructions for implementing a dynamic reminder tool; and one or more processors that execute the instructions to perform operations including: the dynamic reminder tool receiving an indication of a task to be worked on, the task to be worked on associated with a deadline, a party responsible for the deadline, and a cost associated with the deadline, wherein the cost is related to an expense incurred for extending the deadline; the dynamic reminder tool determining, based on the task to be worked on and the deadline, one or more reminders associated with the task to be worked on; the dynamic reminder tool prioritizing the one or more reminders associated with the task to be worked on based on one or more of the deadline, the party responsible, and the cost associated with the task to be worked on; wherein prioritizing the one or more reminders associated with the task to be worked on comprises filtering the one or more reminders based on: at least one parameter, the task to be worked on, and the party responsible; the dynamic reminder tool displaying, on a user interface the at least one or more prioritized reminders; and the dynamic reminder tool dynamically updating the one or more reminders based on the party responsible for the deadline and the cost associated with the deadline.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 depicts a schematic of an automated patent docketing system in an example.

FIG. 2 depicts third-party data sources in an example.

FIG. 3 is a schematic diagram of a docketing system including a dynamic reminder tool in an example.

FIGS. 4A-B depict a user interface dashboard for a dynamic reminder tool in an example.

FIG. 5 depicts a notification hierarchy for a dynamic reminder tool in producing reminders in an example.

FIG. 6 depicts a process of using a dynamic reminder tool for dynamically updating reminders based on the task to be completed in an example.

FIG. 7 depicts a process of using a dynamic reminder tool for dynamically updating reminders based on a user in an example.

FIG. 8 depicts a process of using a dynamic reminder tool for dynamically updating reminders based on costs in an example.

FIG. 9 depicts a process of using a dynamic reminder tool for dynamically updating reminders based on work done in an example.

FIG. 10 depicts an example method of using a dynamic reminder tool for dynamically producing and updating reminders based on work done in an example.

FIG. 11 depicts a computer system in an example.

### DETAILED DESCRIPTION

The present disclosure describes, among other things, a system and method for dynamic reminders for items with legal deadlines. The reminder system may be, for example, configurable by a user, and/or automatically configurable by various types of information such as task to be completed, role of person working on the project, projected costs, and detected activity.

For example, where a patent matter is docketed, the USPTO may send an office action to the patent practitioner firm. The office action may be a non-final rejection of the claims, and have a three-month deadline with no cost, a fourth month deadline requiring a first extension fee, a fifth month deadline requiring a second extension fee, and a final deadline requiring a third extension fee. The patent practitioner, their paralegal, and their admin, among other potential parties, likely all have various duties in attending to this response to the office action.

The firm's docketing system here may intake the item from the USPTO and, such as in an automated or semi-automated docketing system, docket these various deadlines and potential extension fees. The reminder system may work with the docketing system to produce reminders, such as in the form of application notification, emails, texts, in-application tasks, or other reminders to help the practitioner and their team stay on top of the deadlines.

As used herein, “electronic communication” refers to an electronic message or a method of exchanging messages between people using electronic devices.

As used herein, “template” may include a preset format for a document or file, used so that the format does not have to be recreated each time it is used. In some cases, a template may include one or more fields to be filled out.

As used herein, “application” or “program” may include a program or piece of software designed and written to fulfill a particular purpose of the user, such as a database application.

As used herein, “associate” may include a partner or colleague in business or at work, either internal or external.

As used herein, “unstructured text” or “unstructured data” refers to data that is not organized in a standard format, for example, text in the body of an electronic communication.

As used herein, “structured text” or “structured data” refers to data that is organized in a standard format such that a recipient may read the data and institute an automated computing system action without human interpretation of the data.

As used herein, “scraping”, “web scraping”, “data scraping”, or “web crawling”, may refer to automatically mining or collecting data or information, such as from a database or from the internet.

As used herein, “file” or “matter” may refer to a particular project, enterprise, or undertaking being worked on by an individual or a collaborative group, planned and designed to achieve a particular aim.

As used herein, “official record,” or “file history,” may refer to data about a file or matter denoting evidence about past events or tasks within that file or matter, such as an electronic record of previous events. An “official record” may be stored with and maintained by an overseeing agency or organization, such as a governmental organization.

As used herein, “database,” may refer to a structured set of data, such as held in a computer or on the internet, that may be accessible in various ways.

As used herein, “deadline” refers to a target completion date. Deadlines may be set internally, externally, by a third party, or by a governmental agency.

As used herein, “reminder” refers to a prompt or message to a user that indicates a task to be completed.

As used herein, “extension” refers to an extension or postponement of a deadline. For example, an extension may be movement of a deadline date to a later time, for the payment of a fee with a governmental entity.

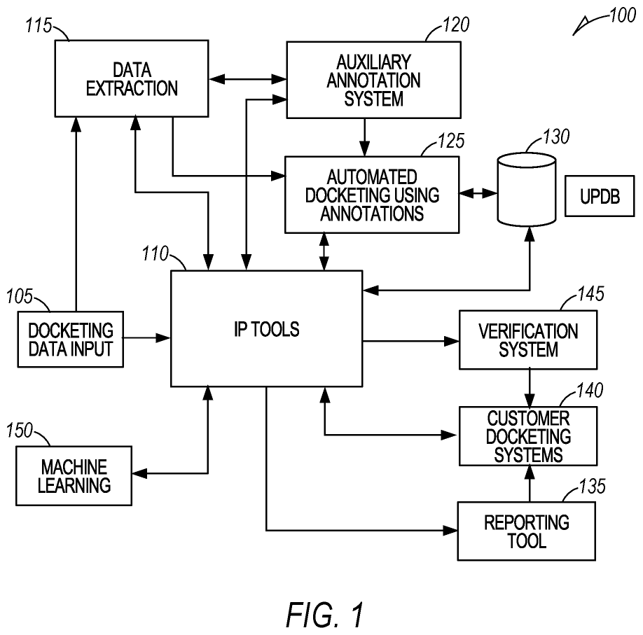

FIG. 1 is a block diagram of a docketing system 100 in an example. The docketing system 100 may be automated or semi-automated. The docketing system 100 may include docketing data input 105, docketing manager 110, data extraction 115, auxiliary annotation system 120, automated docketing using annotations 125, Universal Procedures Database 130, reporting tool 135, customer docketing system 140, verification system 145, and machine learning model system 150.

The automated docketing system 100 may receive documents from third-party sources including third-party docketing systems and/or customer data as docketing data input 105. The docketing manager system 110 may process the received documents to provide to the customer docketing systems 140 and prepare the documents for data extraction by the data extraction system 115 as needed.

The data extraction system 115 may perform Optical Character Recognition (OCR) on the received documents from the docketing manager system 110 to extract data, read checkboxes, extract lists, and identify documents where possible. The docketing manager system 110 may also integrate with a Universal Procedures Database (UPDB) 130 to provide automated docketing by an automated docketing tool 125 that processes received documents based on the additional annotations added to the documents based on the complex data extraction performed by the Auxiliary Annotation System (AAS) 120.

The AAS 120 may further identify the received documents without using an OCR. To manage this process, the docketing manager system 110 may receive frequent updates of docketing procedure rules including configuration data and update the UPDB 130 with universal procedure codes (UPCs) as appropriate. The UPCs may be used in conjunction with customer-specific codes, checklists, and templates. The rules may specify how to fill in the templates and how to complete customer-specific procedures such as how to docket documents into the customer's docketing system 140, for example. The template may be filled out by pulling in attributes from the annotations in a document.

The docketing manager system 110 may receive or intake documents and docketing data from several different sources of docketing data input 105, validate the docketing items against entries in a customer's docketing system 140, and communicate those documents to the customer's docketing system 140 via a unified interface. The docketing manager system 110 may also route documents and associated docketing data through the data extraction system 115 and the AAS 120 and organize the returned metadata and annotations. The docketing manager system 110 thus may provide a breakout between the metadata and the document text.

The docketing manager system 110 may also keep records and communicate with third-party application programming interfaces (APIs) to push the docketing data and documents automatically where allowed. Otherwise, the docketing manager system 110 may present the documents to human docketers to docket. The docketing manager system 110 may also issue reports upon request.

The docketing manager system 110 may be integrated with a customer's existing docketing system (e.g., FOUNDATIONIP®), semi-integrated (e.g., CPI, ANAQUA®, etc.), may provide a virtual host that does not talk at all to the customer's existing docketing system (e.g., IP Manager, MEMOTECH™), or may provide outputs in spreadsheet form for use by a docketing administrator to update the customer's docketing system 140.

If the docketing manager system 110 and the customer's docketing system are not integrated, the data output of automated docketing system 100 may be presented to a human docketer for manual entry. For example, the human docketer may implement macros that interface with the customer's docketing system 140 to populate the received data into the customer's docketing system 140.

On the other hand, if the docketing manager system 110 and the customer's docketing system 140 are integrated or semi-integrated, the data output may be processed to determine if any data is missing to automate the docketing process. If anything is missing, the human docketer may add that information before the automated docketing process may proceed further or the data may be auto-populated and mapped to the template from the UPDB 130.

The automated docketing system 100 may also perform several post-docketing actions, such as sending docketing reports/details to an external verification system 145 that uses a set of rules to verify proper docketing in a host system. The verification system 145 may verify that the data is correctly added to the external customer's docketing system 140. For example, the verification system 145 may pull data from the AAS 120, the docketing manager system 110, and the customer's docketing system 140 to compare what is present to what is expected to be present in the respective systems.

The automated docketing system 100 may also provide automated email “report out” notifications to customers by implementing a reporting tool 135 that specifies docketing actions based on UPDB template configurations. The reporting tool 135 may also provide completed docketing reports to customers either directly or via the customers' docketing system 140.

In some cases, machine learning techniques may be used to generate annotations. For example, a database of past documents that have been identified may be provided by the docketing manager system 110 and used as a data warehouse to train and improve machine learning models by creating a training set for the machine learning model. Over time, the machine learning model system 150 may learn which PTO IDs to use for which documents, which document in a bundle of documents may be used to characterize the bundle, and may provide predicted PTO IDs for the received documents. The machine learning model system 150 may also establish rule engine prediction capabilities for received documents that test the classifications.

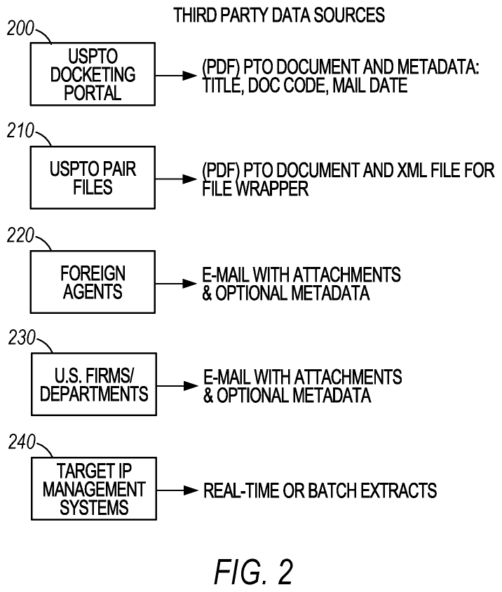

FIG. 2 illustrates sample third-party data sources that provide docketing data input 105 for an automated docketing system 100 implemented for managing patent portfolios in an example. As illustrated in FIG. 2, the third-party data sources may include the Patent Office (e.g., USPTO) docketing portal 200, which provides documents from the USPTO in portable document format (PDF) and includes metadata identifying the title, document code, and mail date for the corresponding document. The third-party data sources may further include USPTO PAIR extensible markup language (XML) files 210, which provide documents from the USPTO in PDF and includes an XML file for patent file wrappers. The third-party data sources may also include foreign agents 220 who provide emails with attachments and optional metadata. Foreign agents 220 may also provide hard copy documents that may be scanned for data entry. Similarly, law firms and/or corporate law departments 230 may provide emails with attachments and optional metadata as well as hard copy documents that may be scanned for data entry. Also, third-party docketing systems 240 may provide real-time or batch extracts of data for entry into a docketing management system.

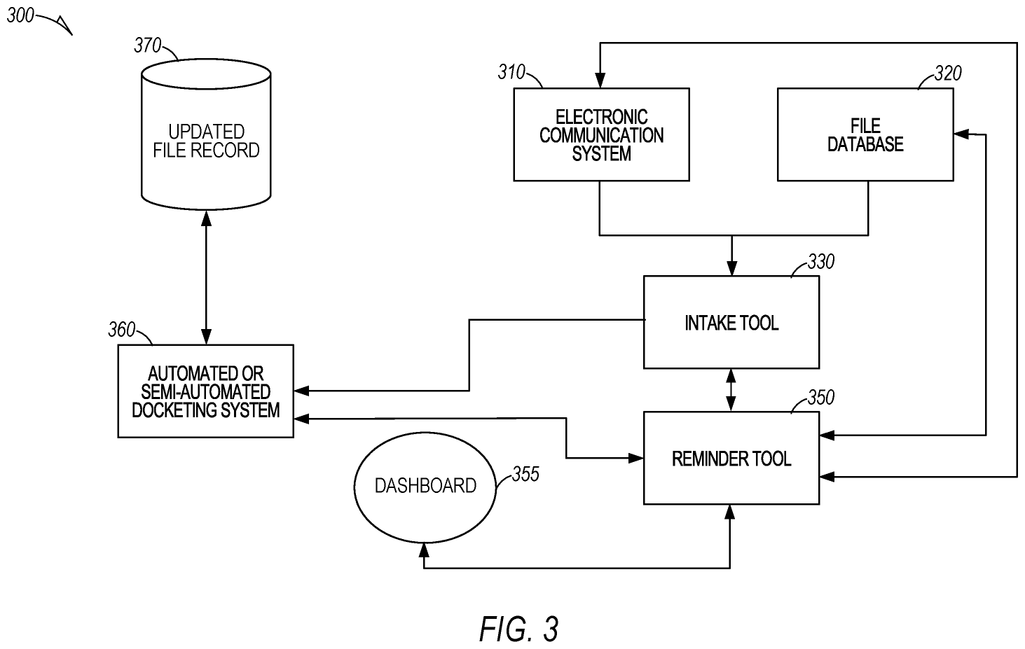

FIG. 3 is a schematic diagram of a docketing system 300 including a dynamic reminder tool 350 in an example. The dynamic reminder tool 350 may be leveraged to help a user manage and track tasks, such as a large docket of tasks, deadlines, and projects, that may be upcoming.

The dynamic reminder tool 300 may include, for example, an electronic communication system 310, a file database 320, an intake tool 330, the reminder tool 350 with a dashboard 355, an automated or semi-automated docketing system 360, and file records 370.

The electronic communication system 310 may be, for example, an e-mail, text, audio file, or other means of communicating with internal and external personnel and entities. The electronic communication system 310 may be a user-accessible system for receiving and/or sending messages, such as through a user interface or other computer. The electronic communication system 310 may be, for example, an e-mail server or other communication system.

The file database 320 may include a repository of files or projects being worked on by the company. The file database 320 may be, for example, a public or private database, such as a governmental run database. In an example, the USPTO PAIR database may be accessed. In an example, ESPACENET may be accessed. In some cases, other databases may be used. In some cases, privately run and updated databases may be accessed. The file database 320 may include information on various files of interest for the business. For example, the file database 320 may include information about patent applications or trademark applications. Such information may, for example, include communications from a governmental agency, responses filed by the company, and other official documents.

The intake tool 330 may include a program or application for receiving electronic communications and associated documents or files. In some cases, the intake tool 330 may be configured to manually or automatically received incoming patent documents or events.

The dynamic reminder tool 350 may take in information from the intake tool 330, the electronic communication system 310, the file database 320, and the file records 370, to review, produce, synthesize, and update a user docket. The dynamic reminder tool 350 may be used in conjunction with the electronic communication system 310, the file database 320, and the file records 370, and communicate therebetween.

The dynamic reminder tool 350 may analyze a user docket or task list to produce a list of reminders. In some cases, the list of reminders may be an e-mail, or produced in a user interface. The list may in some cases be a wholistic list. In some cases, the list may be truncated, such as for a specific time period. The list of reminders may be tailored based on certain prioritized parameters, such as cost, time for completion, or case priority.

For example, the dynamic reminder tool 350 may take in information related to a case A, from the electronic communication system 310, the intake tool 330, the docketing system 360, and the file records 370. The case A may include a first deadline, which does not incur an extension fee, and a second deadline, which does incur an extension fee. Thus, the cost of the extension for the second deadline is related to an expense incurred for extending the deadline. That is, the second, extended deadline incurs a cost, while the first deadline does not. If this is the parameter on which the dynamic reminder tool 350 is prioritizing docket reminders, then the dynamic reminder tool 350 would indicate that the task for the case A should be completed by the first, non-extended deadline, such as to avoid incurring the cost associated with the second, extended deadline.

However, a large number of various parameters may be used when calculating the priority of deadlines. In some instances, the case A's first, non-extended deadline, may fall in the same time frame as another deadline for case B. In this instance, the case B may be higher priority than case A. For this reason, the dynamic reminder tool 350 may analyze the warring deadlines and prioritize the other deadline in case B, indicating that the user could or should let the first deadline in case A lapse and take the second, extended deadline in case A, incurring the associated extension cost.

The dynamic reminder tool 350 takes into account a variety of parameters and priorities when analyzing and making these suggestions. For example, individual preference, the cost of extending, client priority, drop-dead deadlines, high priority tasks, and other factors may be used to synthesize a list of docket reminders, prioritizing some tasks or deadlines over others. This cost-benefit analysis may be wholistic, or may be focused on one or two parameters, such as cost of fees.

The dynamic reminder tool 350 may be used to dynamically alter such a list of reminders. For example, if the case B above is higher priority, the dynamic reminder tool 350 may place tasks for case B higher in the reminder list than those for case A. However, if the user updates the parameters on which the dynamic reminder tool 350 calculates the reminder list, to emphasize cost savings above other priorities, the dynamic reminder tool 350 may raise the first deadline of case A higher to avoid incurring extension costs.

The docketing system 360 may be an automated or semi-automated docketing system, such as the docketing system discussed above with reference to FIG. 1. The docketing system 360 may be in communication with the intake tool 330 and the splitting tool 350, and may receive documents, tasks, and communications with the intake tool 330. The docketing system 360 may communicate with and update the file records 370.

The file records 370 may, for example, be a local or cloud-based file storage system including information on files and projects being worked on at or monitored by the company. The file records 370 may contain historical records, such as past events, communications, and decisions in each file.

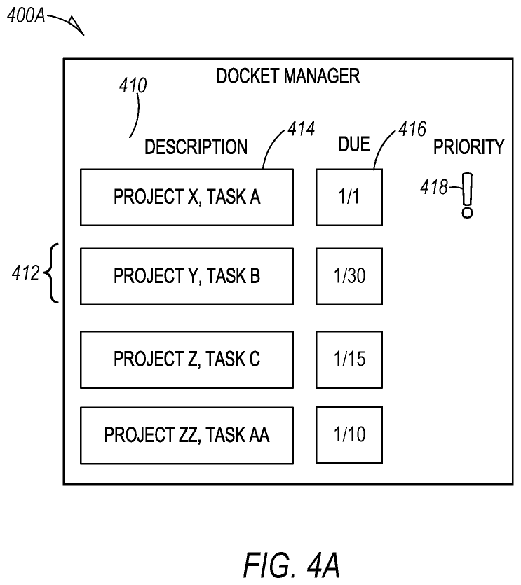

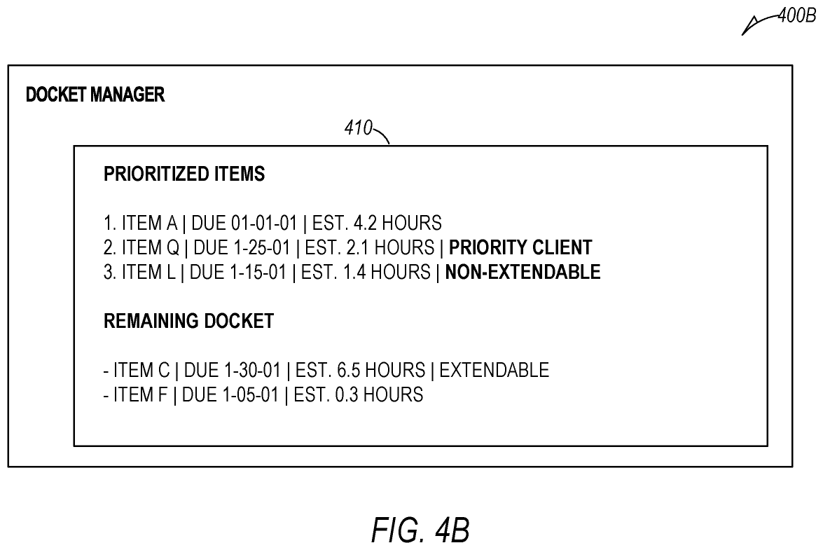

FIGS. 4A-4B depict a user interface dashboard 400 for a dynamic reminder tool in an example. FIG. 4A depicts a first iteration of a user interface 400A, while FIG. 4B depicts a second iteration of a user interface dashboard 400B.

In FIG. 4A, the user interface 400A is shown with a reminder list 410. The reminder list 410 may include individual reminders 412 with descriptions 414, due dates 416, and priority indicators 418. The reminder list 410 may be an example of a reminder list produced by the dynamic reminder tool 350 for use by a user in managing their docket. The reminder list 410 may be produced and dynamically updated by the dynamic reminder tool 350. Similarly, in FIG. 4B, an example of the reminder list 410 is shown in an electronic message format. This may be, for example, a daily email or other message. In the user interface 400A of the dynamic reminder tool 350 itself, the user may optionally add parameters by which the dynamic reminder tool 350 may recalibrate the reminder list 410.

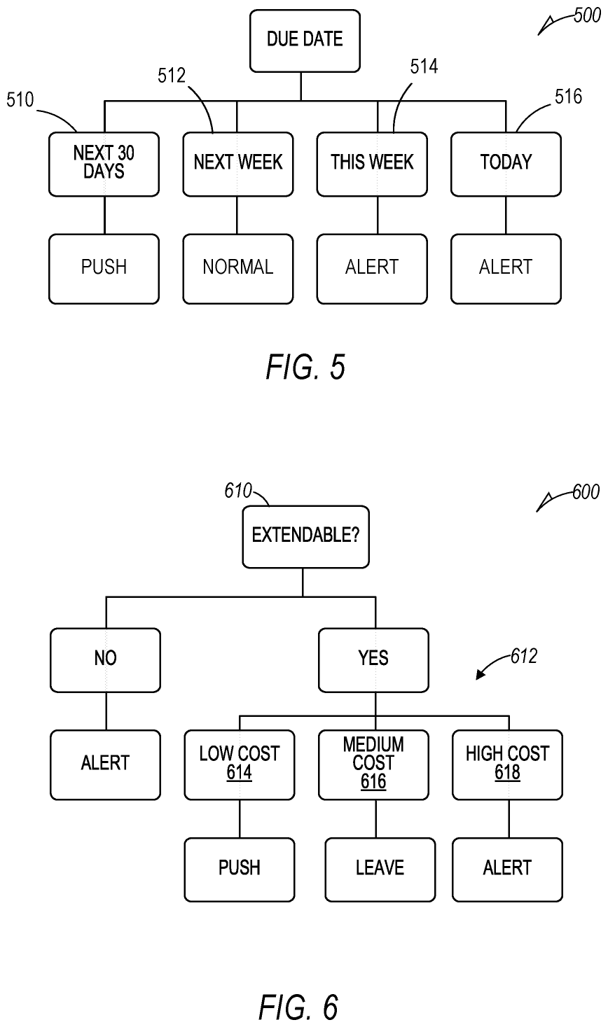

For example, FIG. 5 depicts a notification hierarchy 500 of using a dynamic reminder tool for producing reminders in an example. In the notification hierarchy 500, the dynamic reminder tool 350 may use due dates of tasks to determine what to prioritize in the reminder list. For example, if something is due in the next 30 days (block 510), the reminder tool may push the reminder out past other more urgent deadlines. Similarly, if something is due next week (block 512), the reminder tool may leave that reminder in its original place in line on the reminder list. However, if a task is due this week (block 514) or today (block 516), the reminder tool may put those tasks at the top of the reminder list. In some cases, the reminder tool may additionally or alternatively generate individual alerts to a user for items that are critical, e.g., due this week or today. For example, these alerts may take the form of any suitable alert, such as a push notification, an in-app notification, a notification in the user interface, an e-mail, a text message, or other form of alert.

FIG. 6 depicts a process 600 of using a dynamic reminder tool for dynamically updating reminders based on the task extension to be completed in an example. In the process 600, the parameter under consideration is whether or not a deadline for a task is extendable, and how much extension would cost. For example, at block 610, the reminder tool may ask whether the deadline is extendable or not. If the deadline is not extendable, the reminder tool may push the reminder higher in the reminder list and/or produce an alert to the user. If the deadline is extendable, the reminder tool may ask what the cost for extension is (block 612). If the cost for extension would be low (block 614), the reminder tool may optionally push the reminder for this task lower on the reminder list. If the cost for extension would be average (block 616), the reminder tool may leave the reminder where it is on the reminder list. If the cost for extension would be high (block 618), the reminder tool may place the reminder higher on the reminder list and/or produce an alert to the user.

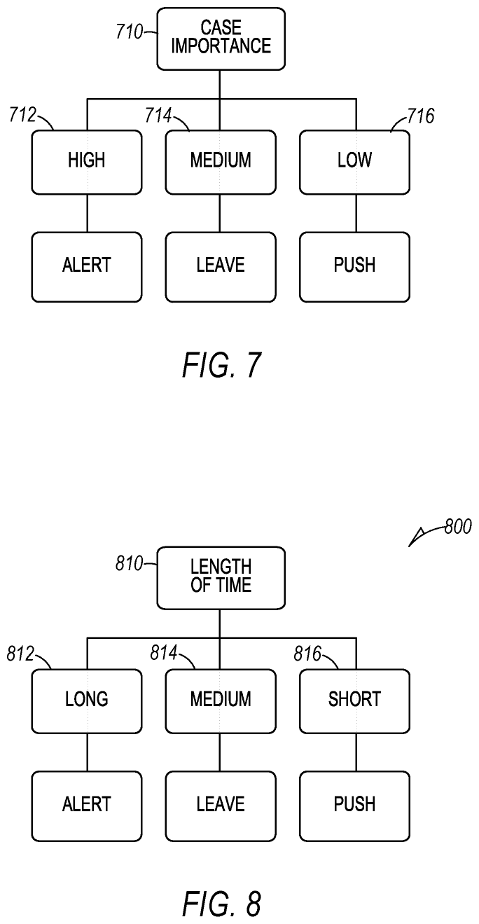

FIG. 7 depicts a process 700 of using a dynamic reminder tool for dynamically updating reminders based on a priority of cases in an example. In the process 700, the reminder tool may weigh a parameter of case or client importance. For example, a high-profile case may be flagged as important in the user interface of the dynamic reminder tool. In this case, the reminder tool may determine the importance of the case or client (block 710). If the case is of the utmost importance (block 712), the reminder tool may prioritize that case, such as by pushing tasks associated with that case higher in the reminder list, and/or creating alerts to the user. If the case is of average importance (block 714), the reminder tool may leave those reminders as they originate. If the case of is lower importance (block 716), the reminder tool may potentially push reminders for tasks in that case lower on the reminder list.

FIG. 8 depicts a process 800 of using a dynamic reminder tool for dynamically updating reminders based on length of time for completion in an example. Here, at block 810, the reminder tool may estimate how long a task will take a user to complete. For example, an office action response may take a user an average of about 4-6 hours to complete. A new application may take between 10-30 hours to complete. By comparison, review of an IDS may take less than half an hour to complete. Based on the user's parameters about length of time to work on a task, the reminder tool may, for example, prioritize tasks that take longer to complete, such as drafting a new patent application (block 812). In this case, the reminder tool may additionally or alternatively create alerts to the user regarding the larger project tasks. In some cases, the reminder tool may also push smaller tasks lower on the reminder list (block 816), and/or leave tasks of medium length where they are on the reminder list (block 818).

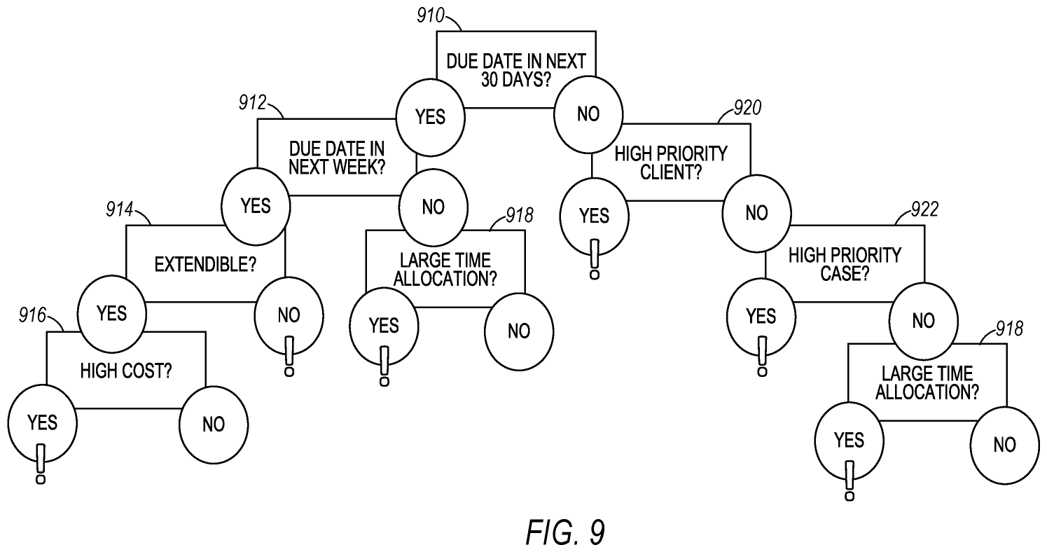

FIG. 9 depicts an example process 900 of using a dynamic reminder tool for dynamically updating reminders based on a variety of parameters. In process 900, the various parameters discussed with reference to FIGS. 5-8 above are combined to show an example synthesis of the reminder tool in producing the reminder list and/or alerts for a user, such as in the user interface shown in FIGS. 4A-4B. A variety of other combinations of parameters may be used with the reminder tool. Any of these parameters may be altered to dynamically update the reminder list and associated alerts.

In the example process 900, the reminder tool may begin by asking whether the task is due in the next 30 days (block 910). If the task is due in the next 30 days, the tool may ask whether the task is due in the next week (block 912). If it is due in the next week, the tool may ask if it is extendable (block 914). If it is not extendable, the tool may create an alert and/or prioritize the task in the reminder list. If the task is extendable, the tool may then ask whether the extension is high cost (block 916). If the task is due in the next week and is extendable, but the cost is high, the tool may create an alert and/or prioritize the task in the reminder list. If the tool determines that the cost is not high for extension, no alert is made. If the due date is not in the next week, the tool may ask whether the task requires a large time allocation (block 918). If it does, the tool may create an alert and/or prioritize the task in the reminder list.

If the task is not due in the next 30 days, the tool may ask whether the client or case is denoted as high priority (blocks 920, 922). If so, the tool may create an alert and/or prioritize the task in the reminder list. If not, the tool may ask whether the task requires a large time allocation. If so, the tool may create an alert and/or prioritize the task in the reminder list. These various junctions may be changed and rearranged based on which parameters are prioritized within the dynamic reminder tool.

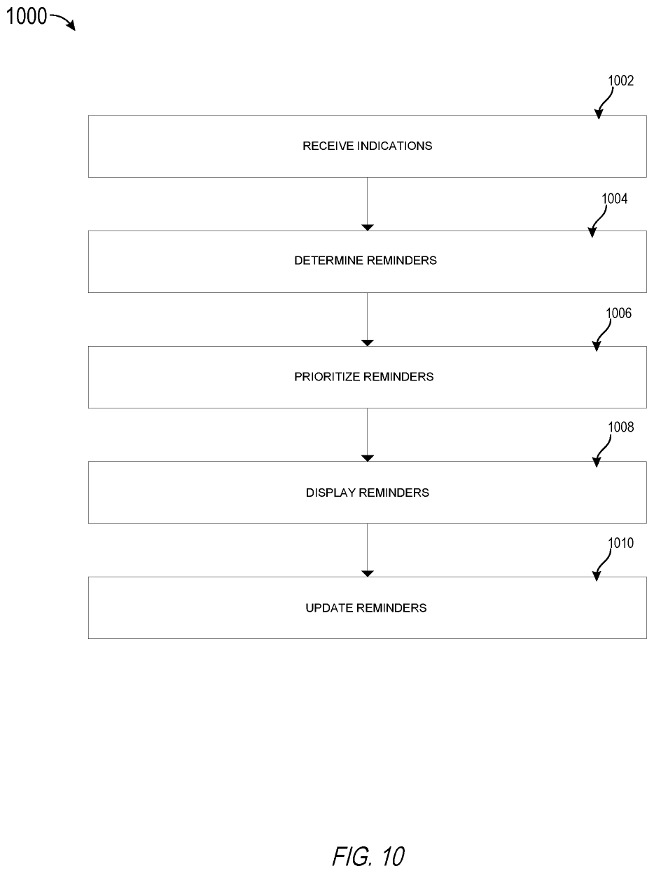

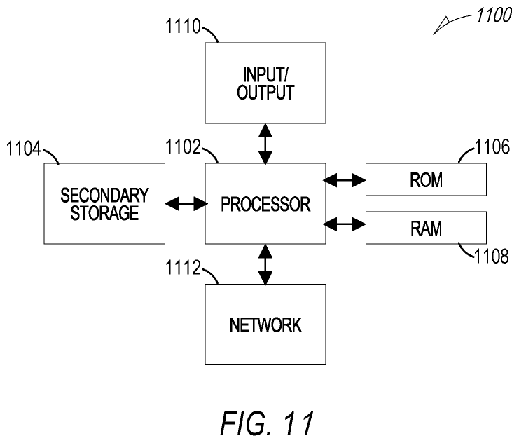

FIG. 10 illustrates an example of a method 1000 for a dynamic reminder tool.

At operation 1002 indications may be received. The indications may be of tasks to be worked on, which are associated with a deadline, a party responsible for the deadline, and a cost associated with the deadline. The cost associated with the deadline may consider the extra expense incurred for extending the deadline.

At operation 1004 reminders may be determined. The reminders are associated with the tasks to be worked on and the deadline associated with the task. For example, if a task is due within six months of receipt, the associated deadline may be a date six months from receipt of the task. Reminders may be determined to make the party responsible for the deadline aware that a final deadline is approaching at various time intervals.

At operation 1006 reminders may be prioritized. Various criteria may be used to prioritize the reminders, such as the amount of time required for the task, the cost of extending a deadline, importance of a matter, or other criteria.

At operation 1008 reminders may be displayed on a user interface in a fashion determined by the prioritization which occurred at operation 1006.

At operation 1010 reminders may be updated based on the party responsible for the deadline and the cost associated with the deadline.

FIG. 11 is a block diagram of a typical, general-purpose computer 1100 that may be programmed into a special purpose computer suitable for implementing one or more embodiments of the manifest record generating program disclosed herein. The manifest record generating program described above may be implemented on any general-purpose processing component, such as a computer with sufficient processing power, memory resources, and communications throughput capability to handle the necessary workload placed upon it. The computer 1100 includes a processor 1102 (which may be referred to as a central processor unit or CPU) that is in communication with memory devices including secondary storage 1104, read only memory (ROM) 1106, random access memory (RAM) 1108, input/output (I/O) devices 1110, and network connectivity devices 1112. The processor 1102 may be implemented as one or more CPU chips or may be part of one or more application specific integrated circuits (ASICs).

The secondary storage 1104 is typically comprised of one or more disk drives or tape drives and is used for non-volatile storage of data and as an over-flow data storage device if RAM 1108 is not large enough to hold all working data. Secondary storage 1104 may be used to store programs that are loaded into RAM 1108 when such programs are selected for execution. The ROM 1106 is used to store instructions and perhaps data that are read during program execution. ROM 1106 is a non-volatile memory device that typically has a small memory capacity relative to the larger memory capacity of secondary storage 1104. The RAM 1108 is used to store volatile data and perhaps to store instructions. Access to both ROM 1106 and RAM 1108 is typically faster than to secondary storage 1104.

The devices described herein may be configured to include computer-readable non-transitory media storing computer-readable instructions and one or more processors coupled to the memory, and when executing the computer readable instructions configure the computer 1100 to perform method steps and operations described above with reference to FIG. 3 to FIG. 10. The computer-readable non-transitory media includes all types of computer-readable media, including magnetic storage media, optical storage media, flash media, and solid-state storage media.

It should be further understood that software including one or more computer-executable instructions that facilitate processing and operations as described above with reference to any one or all of steps of the disclosure may be installed in and sold with one or more servers and/or one or more routers and/or one or more devices within consumer and/or producer domains consistent with the disclosure. Alternatively, the software may be obtained and loaded into one or more servers and/or one or more routers and/or one or more devices within consumer and/or producer domains consistent with the disclosure, including obtaining the software through a physical medium or distribution system, including, for example, from a server owned by the software creator or from a server not owned but used by the software creator. The software may be stored on a server for distribution over the Internet, for example.

Also, it will be understood by one skilled in the art that this disclosure is not limited in its application to the details of construction and the arrangement of components set forth in the description or illustrated in the drawings. The embodiments herein are capable of other embodiments, and capable of being practiced or carried out in various ways. Also, it will be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected”, “coupled”, and “mounted”, and variations thereof herein are used broadly and encompass direct and indirect connections, couplings, and mountings. In addition, the terms “connected” and “coupled” and variations thereof are not restricted to physical or mechanical connections or couplings. Further, terms such as up, down, bottom, and top are relative, and are employed to aid illustration, but are not limiting.

The components of the illustrative devices, systems and methods employed in accordance with the illustrated embodiments may be implemented, at least in part, in digital electronic circuitry, analog electronic circuitry, or in computer hardware, firmware, software, or in combinations of them. These components may be implemented, for example, as a computing program product such as a computing program, program code or computer instructions tangibly embodied in an information carrier, or in a machine-readable storage device, for execution by, or to control the operation of, data processing apparatus such as a programmable processor, a computer, or multiple computers.

A computing program may be written in any form of programming language, including compiled or interpreted languages, and it may be deployed in any form, including as a stand-alone program or as a module, component, subroutine, or other unit suitable for use in a computing environment. A computing program may be deployed to be executed on one computer or on multiple computers at one site or distributed across multiple sites and interconnected by a communication network. Also, functional programs, codes, and code segments for accomplishing the techniques described herein may be easily construed as within the scope of the present disclosure by programmers skilled in the art. Method steps associated with the illustrative embodiments may be performed by one or more programmable processors executing a computing program, code or instructions to perform functions (e.g., by operating on input data and/or generating an output). Method steps may also be performed by, and apparatus may be implemented as, special purpose logic circuitry, e.g., an FPGA (field programmable gate array) or an ASIC (application-specific integrated circuit), for example.

The various illustrative logical blocks, modules, and circuits described in connection with the embodiments disclosed herein may be implemented or performed with a general-purpose processor, a digital signal processor (DSP), an ASIC, a FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computing program include, by way of example, both general and special purpose microprocessors, and any one or more processors of any kind of digital computer. Generally, a processor will receive instructions and data from a read-only memory, a random-access memory, or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computing program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory may be supplemented by or incorporated in special purpose logic circuitry.

Those of skill in the art understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill in the art further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor may read information from, and write information to, the storage medium. In the alternative, the storage medium may be integral to the processor. In other words, the processor and the storage medium may reside in an integrated circuit or be implemented as discrete components.

As used herein, “machine-readable medium” means a device able to store instructions and data temporarily or permanently and may include, but is not limited to, random-access memory (RAM), read-only memory (ROM), buffer memory, flash memory, optical media, magnetic media, cache memory, other types of storage (e.g., Erasable Programmable Read-Only Memory [EEPROM]), and/or any suitable combination thereof. The term “machine-readable medium” should be taken to include a single medium or multiple media (e.g., a centralized or distributed database, or associated caches and servers) able to store processor instructions. The term “machine-readable medium” shall also be taken to include any medium, or combination of multiple media, that is capable of storing instructions for execution by one or more processors, such that the instructions, when executed by one or more processors cause the one or more processors to perform any one or more of the methodologies described herein. Accordingly, a “machine-readable medium” refers to a single storage apparatus or device, as well as “cloud-based” storage systems or storage networks that include multiple storage apparatuses or devices. The term “machine-readable medium” as used herein excludes signals per se.

### Various Notes & Examples

Example 1 is an automated reminder method, the method comprising: receiving an indication of a task to be worked on, the task to be worked on associated with a deadline, a party responsible for the deadline, and a cost associated with the deadline, wherein the cost is related to an expense incurred for extending the deadline; determining, based on the task and the deadline, at least one or more reminders associated with the task to be worked on; prioritizing the one or more reminders associated with the task to be worked on based on one or more of the deadline, the party responsible, and the cost associated with the task to be worked on; displaying, on a user interface at least one of the one or more prioritized reminders; and dynamically updating the one or more reminders based on the party responsible for the deadline and the cost associated with the deadline.

In Example 2, the subject matter of Example 1 optionally includes wherein prioritizing the one or more reminders is done by a user.

In Example 3, the subject matter of any one or more of Examples 1-2 optionally includes wherein prioritizing the one or more reminders comprises filtering the one or more reminders based on at least one parameter.

In Example 4, the subject matter of any one or more of Examples 1-3 optionally includes wherein prioritizing the one or more reminders comprises filtering the one or more reminders based on the task to be worked on.

In Example 5, the subject matter of any one or more of Examples 1-4 optionally includes wherein prioritizing the one or more reminders comprises filtering the one or more reminders based on the party responsible.

In Example 6, the subject matter of any one or more of Examples 1-5 optionally includes wherein prioritizing the one or more reminders comprises adjusting the one or more reminders based on the cost.

In Example 7, the subject matter of any one or more of Examples 1-6 optionally includes wherein dynamically updating the one or more reminders comprises prioritizing a reminder based on upcoming cost.

In Example 8, the subject matter of any one or more of Examples 1-7 optionally includes wherein dynamically updating the one or more reminders comprises indicating urgency of a reminder based on one or more parameters.

In Example 9, the subject matter of any one or more of Examples 1-8 optionally includes wherein dynamically updating the one or more reminders comprises repeating producing a reminder based on one or more parameters.

In Example 10, the subject matter of any one or more of Examples 1-9 optionally includes wherein dynamically updating the one or more reminders comprises prioritizing a reminder above other reminders based on one or more parameters.

In Example 11, the subject matter of any one or more of Examples 1-10 optionally includes wherein dynamically updating the one or more reminders comprises producing an additional reminder based on an indication of work being started on the task to be worked on.

In Example 12, the subject matter of any one or more of Examples 1-11 optionally includes wherein producing, on a user interface, the one or more reminders, comprises producing a dashboard that is user-configurable, wherein producing the one or more reminders is done on the dashboard.

In Example 13, the subject matter of any one or more of Examples 1-12 optionally includes wherein dynamically updating the one or more reminders is done on the dashboard and comprises producing an additional reminder based on an indication of upcoming higher costs associated with the task to be worked on.

Example 14 is a system for creating automated reminders, the system comprising: a memory that stores instructions for implementing a dynamic reminder tool; and one or more processors that execute the instructions to perform operations including: the dynamic reminder tool receiving an indication of a task to be worked on, the task to be worked on associated with a deadline, a party responsible for the deadline, and a cost associated with the deadline, wherein the cost is related to an expense incurred for extending the deadline; the dynamic reminder tool determining, based on the task to be worked on and the deadline, one or more reminders associated with the task to be worked on; the dynamic reminder tool prioritizing the one or more reminders associated with the task to be worked on based on one or more of the deadline, the party responsible, and the cost associated with the task to be worked on; wherein prioritizing the one or more reminders associated with the task to be worked on comprises filtering the one or more reminders based on: at least one parameter, the task to be worked on, and the party responsible; the dynamic reminder tool displaying, on a user interface the at least one or more prioritized reminders; and the dynamic reminder tool dynamically updating the one or more reminders based on the party responsible for the deadline and the cost associated with the deadline.

In Example 15, the subject matter of Example 16 optionally includes wherein prioritizing the one or more reminders associated with the task to be worked on comprises adjusting the one or more reminders based on the cost.

In Example 16, the subject of any one or more Examples 14-15 optionally includes dynamically updating the one or more reminders comprises: prioritizing a reminder based on upcoming cost; indicating urgency of a reminder based on one or more parameters; and repeating producing a reminder based on one or more parameters.

In Example 17, the subject matter of any one or more of Examples 14-16 optionally includes wherein dynamically updating the one or more reminders comprises prioritizing a reminder above other reminders based on one or more parameters.

In Example 18, the subject matter of any one or more of Examples 14-17 optionally includes wherein dynamically updating the one or more reminders comprises producing an additional reminder based on an indication of work being started on the task to be worked on.

In Example 19, the subject matter of any one or more of Examples 14-18 optionally includes wherein displaying, on a user interface, the one or more reminders, comprises producing a dashboard that is user-configurable, wherein displaying the one or more reminders is done on the dashboard.

In Example 20, the subject matter of any one or more of Examples 14-19 optionally includes wherein dynamically updating the one or more reminders is done on the dashboard and comprises producing an additional reminder based on an indication of upcoming higher costs associated with the task to be worked on.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more”. In this document, the term “or” is used to refer to a nonexclusive or, such that “A or B” includes “A but not B”, “B but not A”, and “A and B”, unless otherwise indicated. In this document, the terms “including” and “in which” are used as the plain-English equivalents of the respective terms “comprising” and “wherein”. Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first”, “second”, and “third”, etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. An automated reminder method comprising:
receiving an indication of a task to be worked on, the task to be worked on associated with a deadline, a party responsible for the deadline, and a cost associated with the deadline, wherein the cost is related to an expense incurred for extending the deadline;
determining, based on the task and the deadline, at least one or more reminders associated with the task to be worked on;
prioritizing the one or more reminders associated with the task to be worked on based on one or more of the deadline, the party responsible, and the cost associated with the task to be worked on;
displaying, on a user interface at least one of the one or more prioritized reminders; and
dynamically updating the one or more reminders based on the party responsible for the deadline and the cost associated with the deadline.

2. The method of claim 1, wherein configuring the one or more reminders is done by a user.

3. The method of claim 1, wherein configuring the one or more reminders comprises filtering the one or more reminders based on at least one parameter.

4. The method of claim 1, wherein configuring the one or more reminders comprises filtering the one or more reminders based on the task to be worked on.

5. The method of claim 1, wherein configuring the one or more reminders comprises filtering the one or more reminders based on the party responsible.

6. The method of claim 1, wherein configuring the one or more reminders comprises adjusting the one or more reminders based on the cost.

7. The method of claim 1, wherein dynamically updating the one or more reminders comprises prioritizing a reminder based on upcoming cost.

8. The method of claim 1, wherein dynamically updating the one or more reminders comprises indicating urgency of a reminder based on one or more parameters.

9. The method of claim 1, wherein dynamically updating the one or more reminders comprises repeating producing a reminder based on one or more parameters.

10. The method of claim 1, wherein dynamically updating the one or more reminders comprises prioritizing a reminder above other reminders based on one or more parameters.

11. The method of claim 1, wherein dynamically updating the one or more reminders comprises producing an additional reminder based on an indication of work being started on the task to be worked on.

12. The method of claim 1, wherein producing, on a user interface, the one or more reminders, comprises producing a dashboard that is user-configurable, wherein producing the one or more reminders is done on the dashboard.

13. The method of claim 12, wherein dynamically updating the one or more reminders is done on the dashboard and comprises producing an additional reminder based on an indication of upcoming higher costs associated with the task to be worked on.

14. A system for creating automated reminders, the system comprising:
a memory that stores instructions for implementing a dynamic reminder tool; and
one or more processors that execute the instructions to perform operations including:
the dynamic reminder tool receiving an indication of a task to be worked on, the task to be worked on associated with a deadline, a party responsible for the deadline, and a cost associated with the deadline, wherein the cost is related to an expense incurred for extending the deadline;
the dynamic reminder tool determining, based on the task to be worked on and the deadline, one or more reminders associated with the task to be worked on;
the dynamic reminder tool prioritizing the one or more reminders associated with the task to be worked on based on one or more of the deadline, the party responsible, and the cost associated with the task to be worked on;
wherein prioritizing the one or more reminders associated with the task to be worked on comprises filtering the one or more reminders based on: at least one parameter, the task to be worked on, and the party responsible;
the dynamic reminder tool displaying, on a user interface the at least one or more reminders prioritized reminders; and
the dynamic reminder tool dynamically updating the one or more reminders based on the party responsible for the deadline and the cost associated with the deadline.

15. The system of claim 14, wherein prioritizing the one or more reminders associated with the task to be worked on comprises adjusting the one or more reminders based on the cost.

16. The system of claim 14, wherein dynamically updating the one or more reminders comprises:
prioritizing a reminder based on upcoming cost;
indicating urgency of a reminder based on one or more parameters; and
repeating producing a reminder based on one or more parameters.

17. The system of claim 14, wherein dynamically updating the one or more reminders comprises prioritizing a reminder above other reminders based on one or more parameters.

18. The system of claim 14 wherein dynamically updating the one or more reminders comprises producing an additional reminder based on an indication of work being started on the task to be worked on.

19. The system of claim 14, wherein displaying, on a user interface, the one or more reminders comprises producing a dashboard that is user-configurable, wherein displaying the one or more reminders is done on the dashboard.

20. The system of claim 19, wherein dynamically updating the one or more reminders is done on the dashboard and comprises producing an additional reminder based on an indication of upcoming higher costs associated with the task to be worked on.
